(19) United States
(12) Patent Application Publication
(10) Pub. No.: US 2007/0286145 A1
(43) Pub. Date: Dec. 13, 2007

(54) Method of Operation of Terminal Device in Mobile System

(75) Inventors: Pekka Pakkila, Oulu (FI); Hannu Niemitalo, Oulu (FI)

Correspondence Address: CONNOLLY BOVE LODGE & HUTZ LLP, 1875 EYE STREET, N.W., SUITE 1100, WASHINGTON, DC, 20036, US

(73) Assignee: PANCOMP ELECTRONICS OY, Oulu (FI)

(21) Appl. No.: 10/590,327

(22) PCT Filed: Feb. 24, 2005
(86) PCT No.: PCT/FI05/00114

§ 371 Date: Jul. 5, 2007

(30) Foreign Application Priority Data
Feb. 25, 2004 (FI) 20040288

(51) Int. Cl. H04Q 7/32

(52) U.S. Cl. 370/340

(57) ABSTRACT

In a method of operation of a terminal device in a mobile system, the terminal device (Ln) is kept dominantly in a deep rest state (P0) for minimizing the current consumption and means and functions for making the terminal device to operate as a terminal device in a mobile communication network are activated (CL) for short periods (tc1) for sending (R) or receiving (H) data, and the activation and operation of the terminal device for sending and receiving data is controlled individually by control data which is sent to the terminal device via the mobile communication network (24). The centralized and at the same time individual control of the terminal devices makes it possible to apply the mobile system to many purposes. The current consumption and the communication costs may be minimized and a very high operational dependability be realized in the system.

### FIELD OF THE INVENTION

The invention is related to a method of operation of a terminal device in a mobile system, e.g. a data acquisition system. This kind of system may be applied to supervising the work of mobile staff and gathering information related to it, for example.

### BACKGROUND OF THE INVENTION

It is known to combine terminal devices of a data acquisition system and a mobile telecommunication network to provide a mobile data acquisition system, for example.

EP 1093091 presents e.g. a data gathering device for gathering information about employees' working hours for wages accounting or about the use of materials or equipment, in which data gathering device a terminal operating in a mobile telecommunication network is combined with a reader device. The data gathering device is provided with a browser, and it is via the telecommunication network and a gateway connected to Internet whereby an Internet connection may be established to a central device provided with a browser. The telecommunication network may be a GSM, GPRS or UMTS network. The terminal device may be a WAP terminal device.

WO 0174101 presents a data acquisition system e.g. for positioning employees and for supervising work. In a preferred embodiment of the system, a bar code reader is connected to a communicator type mobile phone device, for example, and short message system is preferably used for transmitting data. An application is accomplished in the terminal device which includes a user interface, takes care of the operation of the reader and achieves SMS messages and provides commands to achieve them. In the servers of an operator, an application may be accomplished by means of which SMS messages may be sent to a selected IP address. The application may be realized in terminal devices provided with new operating systems (e.g. Symbian). Data transfer may be accomplished also by means of other services, e.g. data calls or WAP services or future UMTS network data services.

WO 0173687 presents a small portable data acquisition device which is meant e.g. for reading identification data from interesting products or other things so that wider information is later attained by means of the identification data, e.g. databases, web pages or other information. A preferred way of using the device is that the user discharges the data from the data acquisition device by means of a suitable interface to a computer, for example, for treating and further utilizing the data. The data acquisition device may also be combined with or connectable to a mobile phone or a PDA device provided for wireless data transfer whereby Internet services are directly available or databases may be used otherwise for sending or receiving data.

In the above known solutions, the terminal device is combined with a new generation mobile terminal device. The use of this kind of advanced device is quite complicated, and e.g. a person doing simple work is often unaccustomed to use such devices. In consequence of this, usage problems and mistakes are probable and to large extent jeopardize the benefits which would be obtained from the usage of the system. If a terminal is operating in the network continuously, and if it is used at the same time for other purposes than gathering data, also the situations are most probable in which the battery of the device is exhausted before the working day is finished and the data of the rest of the day remain ungathered. The above documents do not present solutions for operation of a terminal device with which such problems would be avoided.

### SUMMARY OF THE INVENTION

An object of the invention is to present such a method of operation of a terminal device in a mobile system which to large extent solves the problems described above.

A method of operation of a terminal device in a mobile system according to the invention, in which method the terminal device includes means and functions for reading data from an object and for storing the data and means and functions for making the terminal device to operate as a terminal device of a mobile telecommunication network for sending and receiving data, is characterized in that which is defined in the characterizing part of claim 1. Other claims define various embodiments of the invention.

With the method of the invention, the current consumption of the terminal device may be minimized. When desired, all the telecommunication traffic may be accomplished so that the management system starts it. It may be accomplished also so that the connection is always set up from the side of the management system whereby the terminal device causes no telecommunication costs at all. The necessary data transfer may also be accomplished, as the case may be, in the most advantageous way and at the most advantageous time. When desired, the telecommunication costs may be minimized. On the other hand, it is possible to control the terminal devices individually according to needs to set up a connection and to report information to the management system. In this way, the work of a new employee may be supervised and controlled more accurately, for example, when for old workers it is enough only to have a report once a day. The centralized and at the same time individual control of the terminal devices makes it possible to apply the mobile system flexibly to many purposes. At the same time, the usage of the terminal device may be made as simple as possible and advantageous according to need and a very high operational dependability be realized in the system.

### BRIEF DESCRIPTION OF THE DRAWINGS

The invention and some embodiments thereof are described in the the following in further detail with reference to the accompanying drawings, in which:

FIG. 1 is a block diagram presenting a possible realization of a terminal device of a mobile system;

FIG. 2 presents schematically a possible realization of such a mobile system in which the method of the invention may be applied;

FIGS. 3 to 8 are schematic diagrams presenting examples of various embodiments of the method of the invention;

FIG. 9 is a schematic diagram presenting an alternative data transfer method in relation to the method of the invention; and

FIG. 10 is a schematic diagram presenting an example of realizing the control of the terminal device in the method of the invention.

### DETAILED DESCRIPTION OF THE INVENTION

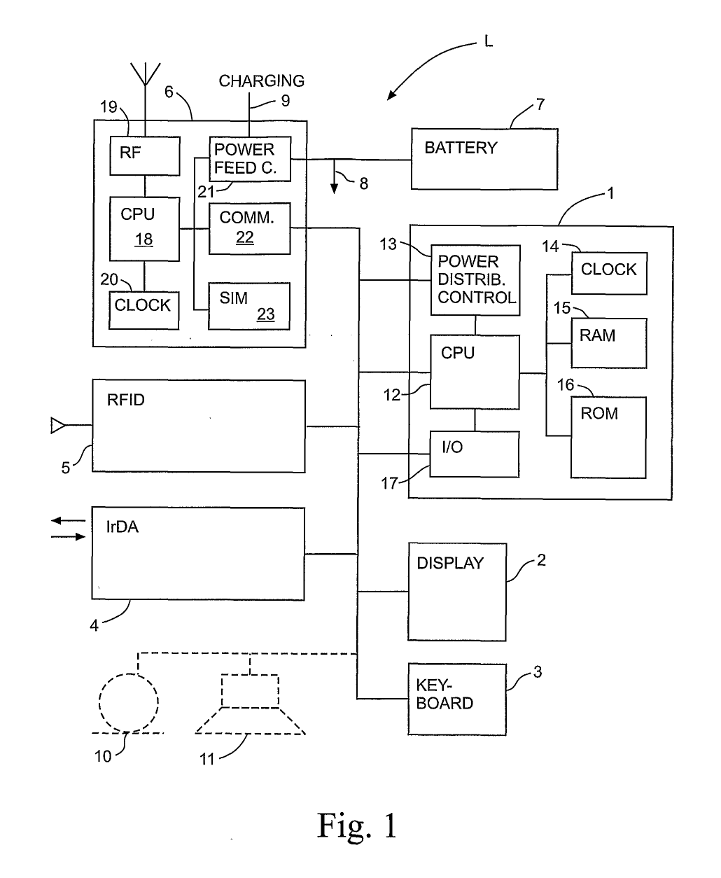

The terminal device L of FIG. 1 includes a processor unit 1, a display 2, a keyboard 3, an IRDA interface unit 4, an RFID reader unit 5, a GSM unit 6, and a battery 7 and possibly a microphone 10 and a speaker 11.

The battery 7 is connected to a conventional power control unit 21 of the GSM unit and to a charging connector 9 in connection with it and is supplying current to all parts of the terminal device as indicated by reference number 8.

The GSM unit 6 includes additionally a conventional radio frequency unit 19 operating in the frequencies of 900/1800 Mhz, a processor and memories 18, a real time clock 20, a SIM card 23, and a communication unit 22 by means of which the GSM unit communicates serially with the processor unit 1 of the terminal device.

In connection with the clock 20 there is also a battery backup by means of which necessary data is preserved in the device during some weeks when the device is switched off.

The processor unit 1 includes a processor 12, a RAM memory 15, a ROM memory 16, e.g. a Flash-ROM memory for programs and an EEPROM memory for report data, and conventional I/O circuits 17 for the display and the keyboard. As to the operation method of the terminal device, an interruption clock 14, which is working also when the terminal device is in rest state, and a power supply control unit 13 are essential parts.

The RFID reader unit 5 is conventional and includes an antenna transmitting power and signal for reading a RFID tag, a control unit, and a communication unit for serial communication with the processor unit 1. The RFID unit may be a device the operating frequency of which is 125 Mhz or 13,56 Mhz. It may include also a writer function.

The display may be a LCD but it may also be formed of some signal LEDs. The most simple user interface may include only one key as a keyboard 3, but there may naturally be more keys, too. The keyboard may be also similar to a keyboard of a conventional mobile phone, for example.

The IrDA unit 4 includes conventional circuits and transmitter and receiver diodes for serial optical communication with e.g. a computer which is provided with a corresponding interface.

The terminal device may include also a microphone 10 and a loudspeaker 11 accomplished with techniques known from mobile phones, for example. Moreover, also a signal tone function may be accomplished in the terminal device.

A suitable charger intended for mobile phones may be used for charging the battery.

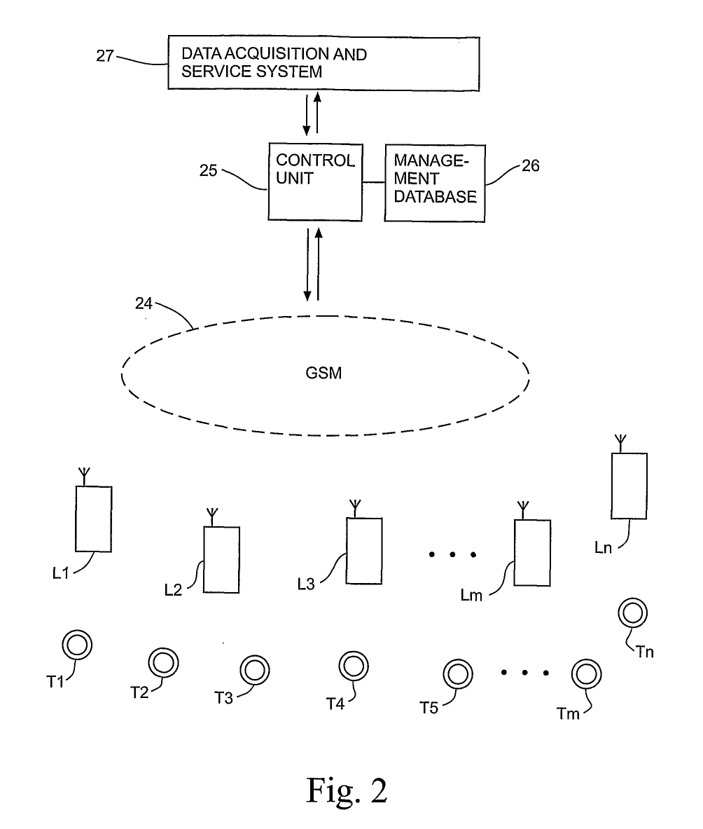

FIG. 2 presents a mobile data acquisition system in which the method of the invention may be applied. The user of the data acquisition system may be a service company, e.g. cleaning or building maintenance company, the workers of which normally visit several places of work during a working day for taking care of the scheduled jobs. The working places have been provided with RFID tags T1, T2, T3, T4, T5, . . . , Tm, Tn. Each one of the workers has a terminal device L1, L2, L3, . . . , Lm, Ln similar to that described above. The terminal device is normally in rest state in which the current consumption is minimal. By means of the RFID reader of the terminal device a worker registers his or her arrival at a working place and correspondingly the departure when leaving the place. The control of the data acquisition system is centralized. For that, there is e.g. one control unit 25 and in connection with it a management database 26. The control unit 25 is communicating with the terminal devices by sending them control data and receiving reports from them. The reported information is delivered forward to a data acquisition and service system which may serve several clients and which works up the reported information into a desired mode or uses it for working time control and wages accounting. The communication between the central unit 25 and the terminal devices L1, . . . , Ln is carried out by means of a mobile phone network 24, e.g. a GSM network, for example.

It is essential in the method of operation of the terminal device that the device is kept dominantly in a deep rest state in which the current consumption is very low, e.g. less than 1 mA. Only the interruption clock 14 is then active. The terminal device is woken up from this rest state only by a command from the clock or a press of a key, or as it is connected to a charger. Advantageously, there are several operation modes in the terminal device for carrying out different tasks, whereby the current consumption may be minimized for each task.

In the first operation mode, the standby mode, the processor unit 1 is ready for operation and the other units, i.e. the GSM, RFID and IrDA units, are without current. The current consumption is then less than 20 mA. In the second operation mode, additionally the IrDA unit 4 is temporarily activated, and the current consumption is less than 30 mA. This operation mode is used only when data is discharged from or loaded to the terminal device e.g. via a computer provided with an IrDA interface. In the third operation mode, the RFID unit 5 in addition to the processor unit 1 is temporarily activated. The current consumption is then less than 60 mA. This operation mode is used most often, i.e. when reading RFID tags. The terminal device is activated to this as well as other two operation modes by suitable simple key operations, for example.

In the fourth operation mode, the GSM unit 6 is temporarily activated in addition to the processor unit, and the current consumption is less than 300 mA. The terminal device is activated to this operation mode preferably on its own initiative according to parameters got and saved from the control data.

As far as the user is concerned, the way of using the terminal device of the mobile system according to the invention is as follows. The user keeps the terminal device in a belt bag or some other place where it is easily available. Arriving at the place of work, surveillance or other service, the user presses a key or performs a certain key operation and is bringing the device close to a tag provided for that at the place. The terminal device is woken up from the rest state to the tag reading state and acknowledges the successful reading of the tag by a light or tone signal. The user puts the device back into its keeping place. The terminal device saves the read data, in which the basic information is an identification code, and other data, e.g. time data, related to it into a report memory. If the data includes control data, the device is operating according to it or saves the data for future operations. As the software finds that the necessary operations have been carried out, the terminal device is returned back to the rest state.

Leaving the place, the user carries out the same actions whereby the device checks the user out of the place and performs the same or corresponding operations as at the arrival.

As the terminal device gives an alarm, the user is connecting it for charging. The terminal device is turned from the rest state to the operation mode in which the functions needed for charging are started. Related to the charging, there may be data transfer operations in accordance with the control data a certain time after starting the charging, which is considered in further detail here below. The battery being charged full, the terminal device stops charging and is returned back to the rest state.

The communication with the management system via a telecommunication network, e.g. the above mentioned GSM network, the terminal device performs mainly on its own initiative according to the control data it has received.

FIG. 10 is a schematic diagram describing an example of the individual control of the terminal device. In relation to the control unit 25, parameters specific to each individual terminal device are set to be stored e.g. in the management database 26, an example of such parameters being presented in table 28. The terminal device concerned, its telephone number in the telecommunication network, and the person, e.g. a worker, using the device are identified in the title row. Parameters A1 give such tag codes, e.g. of tags placed in hospitals, which prevent the use of the mobile phone part of the terminal device. The next parameters, with the initial B, define data transfer via a data connection between the management system and the terminal device. B1 defines that only the management system is allowed to call the terminal device. B2 defines numbers to which the connection from the terminal device is allowed. B3 defines a point of time, i.e. a day and a clock time, when the terminal device must next time activate the GSM unit for a call expected to come. Also one or more clock times could be defined here at which the activation is to be made every day.

The control data may include also other parameters than those related to the communication. In the example of FIG. 10, D1 defines a lower limit of the battery voltage with which the call for connection is allowed. D2 defines a lower limit of the battery voltage at which the charging alarm is given to the user. E1 defines the time in minutes within which the reading of a tag must be done after pressing the key, and E2 defines the time in minutes after which the device must return to the rest state after reading a tag.

If also a call for connection is allowed for the terminal device concerned, additional parameter definitions may include: tags which order the device to take a call for connection to the management system, the largest allowed interval between connections, the waiting time before retry in the busy situation and maximum amount of possible retries.

The data transfer may be defined to be carried out totally by means of text messages, or additionally data calls may be defined as allowed in certain situations. In each case, parameters necessary for managing the communication and for controlling otherwise the terminal device are defined in a similar way as in the above example.

FIG. 10 presents also schematically the transfer of the control data from the control unit 25 to the terminal device Ln. The parameters have been arranged into a control data field 28′, confined with start and end marks 31 and 32, in a data packet 30 including also other data, e.g. address data, which packet is delivered to the terminal device through a connection 29 set up in the network 24.

If the control data is sent as a text message, it may include e.g. a start mark, identifiers of the sender and the receiver, time, control data, check mark, and end mark. Control data may be sent also as a text message including only the control data, because in many cases there are no other necessary data, or that kind of data is otherwise clear or easily available.

Mainly report data is sent from the terminal device to the control unit, but also e.g. state data may be sent in the same way as from the control unit to the terminal device. The data sent to the terminal device may include also plain text instructions for the user displayed on the display of the device.

When a data connection is used, the data is transferred with a method according to e.g. TFTP or UDP protocols in which the report or control data is framed and packed according to the requirements of the transfer connection into suitable blocks the passage through of which me be assured at several levels.

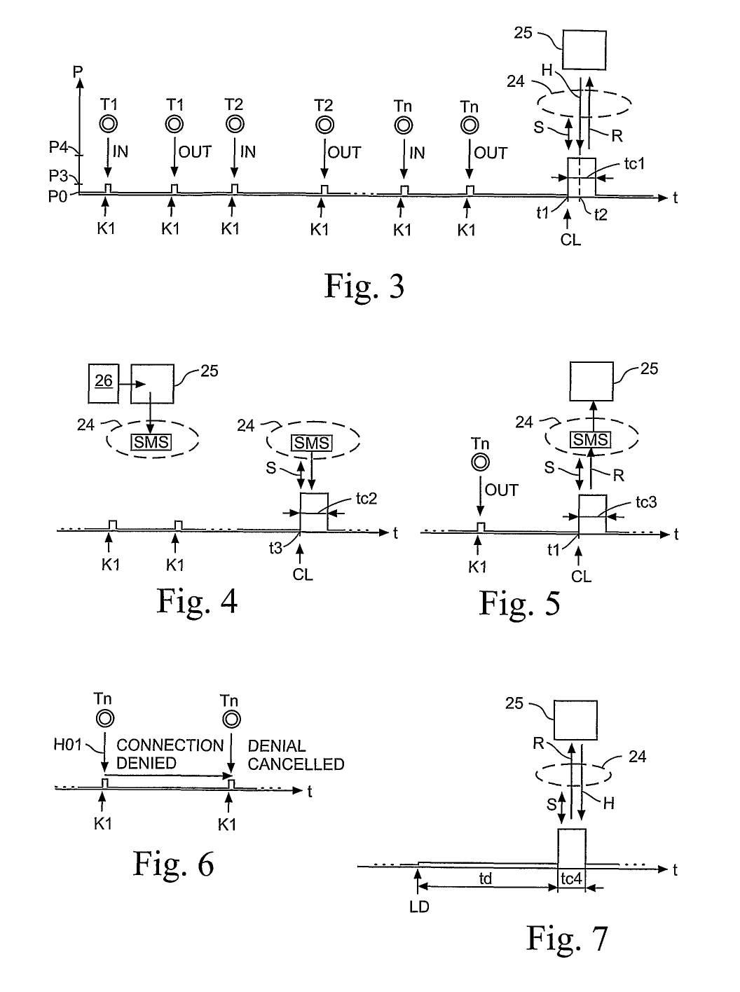

FIGS. 3 to 8 present examples of the operation of the terminal device according to the invention. FIG. 3 presents schematically that the terminal device is during a working day mostly in the rest state in which the current consumption P is minimal P0. The user activates the device at need, e.g. when arriving at the place of work and leaving the place, with a key operation K1 to read the corresponding RFID tag T1, T2, . . . , Tn. The working day being finished, a signal CL given by the interruption clock activates at the time t1, which is in accordance with the control parameters given to the device, the GSM unit which is registered in the network 24 as an available subscriber by means of signaling operations indicated by arrow S. The central unit 25 establishes at a defined time t2 a connection to the terminal device, as indicated by arrow H, and may at the same time send new or compensating control data to the device, and the terminal device sends the report data gathered during the day in the way indicated by arrow R. After that, the terminal device is again returned back to the rest state. The GSM unit has been active for a short period tc1.

FIG. 4 presents a situation in which the data transfer between the management system and the terminal device is performed by means of text messages. The central unit 25 forms from the control data obtained from the management database 26 a text message SMS addressed to the terminal device concerned and sends it. As the GSM unit of the terminal device is at that time not active, the terminal device is not available in the network 24 but the text message is stored to wait for the activation of the recipient. A signal CL of the interruption clock activates the terminal device at time t3 whereby the terminal device after signaling operations S obtains automatically the text message SMS from the network and the control data included in it and then returns again back to the rest state. The GSM unit has been active for a short period tc2.

The receipt of the control data as text messages may naturally be related to sending the report data as text messages during the same connection period. The terminal device in routine use may operate in the way described by FIG. 5 which is otherwise like FIG. 3 but the terminal device is guided only to send, after registration S, the report data gathered during the day as a text message SMS to the control unit 25. If there are any incoming control or other data from the control unit on the way as a text message, the terminal device receives it at the same time. After sending and possibly receiving text messages, the terminal device is again returned back to the rest state. The GSM unit has been active for a short period tc3.

FIG. 6 illustrates the situation in which the terminal device receives control data from a tag. The user arriving at a certain place, the terminal device receives after the read command K1 from the tag Tn a control code H01 which is defined in the control parameters of the terminal device to set a connection denial in the device. The place may be a hospital, for example, in which the usage of mobile phones is denied. The user leaving the place and reading the tag again, the denial is canceled.

FIG. 7 illustrates the case in which the terminal device is guided to perform the reporting in relation to the charging. The charging begins at the point indicated by arrow LD whereby the functions of the terminal device necessary for charging are activated. For assuring that there is enough current for reporting, a delay td is set in the control parameters, after which delay from the start of the charging the GSM unit is activated, the terminal device is registered in the network as indicated by arrow S, and the terminal device is setting up a connection to the control device 25 as indicated by arrow R and performs reporting, whereby the central unit may at the same time send control and other data to the terminal device as indicated by arrow H. After that, the terminal device is returned to the charging mode. The GSM unit has been active for a short period tc4.

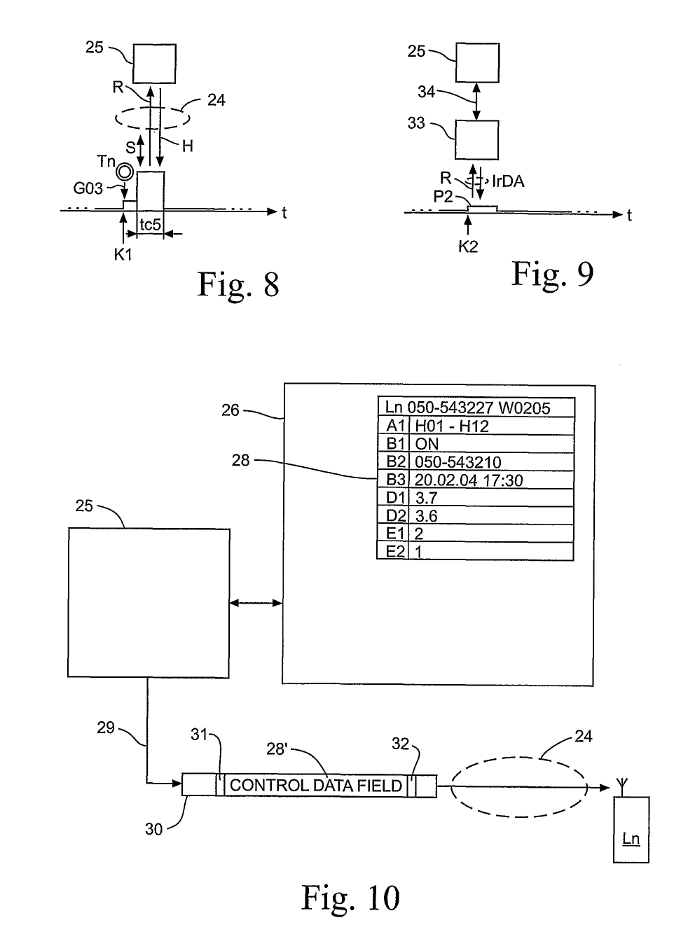

FIG. 8 illustrates another situation in which the terminal device receives control data from a tag. The user arriving at a certain place, the terminal device receives after the read command K1 from the tag Tn a control code G03 which commands the terminal device to set up a connection to the control unit 25 and perform reporting. This happens immediately after reading the tag in the way described above, after which the terminal device is returned back to the rest state. The GSM unit has been active for a short period tc5.

The terminal device may include also an IrDA interface as described above. The reporting to the central unit 25 may then be carried out in accordance with FIG. 9. The terminal device is activated by a key operation K2 into the operation mode in which the IrDA unit is active and the current consumption level is P2. As indicated by arrow R, the terminal device may perform reporting to e.g. a computer 33 which establishes an Internet connection 34 to the control unit. The terminal device may at the same time obtain data from the management system. The intermediating device 33 may be also a mobile phone, communicator or other similar device provided with an IrDA interface.

In the purposes considered above, for example, the terminal device may be 98 percent of the time in the rest state, 1.8 percent of the time in the tag reading state, and 0.2 percent of the time in the GSM communication state. During one week, the current consumption is then less than 170 mAh in the rest state, less than 130 mAh in the tag reading state, and less than 100 mAh in the GSM communication state, i.e. in total 400 mAh during one week.

The current consumption is kept as low as possible so that, in the rest state, the minimizing of the current consumption is working at the hardware level, whereas returning from the operation states to the rest state is accelerated by software.

Concerning the current consumption in the GSM state, it is essential to minimize the amount of connections which may normally be one connection per day. In the terminal devices in normal use, the same control characteristics may be kept continuously whereby said devices are activated for connection or set up a connection and send a report daily at the same time, without any need to set up a connection or using a connection set up for receiving control data. As to the current consumption, the data transfer in SMS messages is more advantageous than using data connections.

In telecommunication, solutions reducing current consumption reduce normally also costs. In the method of the invention, telecommunication costs may be minimized further by said centralization of the telecommunication to be initiated by the management system whereby the costs are directed to only one GSM subscriber. The use of text messages for data transfer is advantageous firstly because a terminal device may collect the message at any desired time free of charge, and secondly because the text messages may also be sent at an advantageous time, e.g. at nights or weekends, without any dependency on the receiving time, or under advantageous terms of contract. During the same one connection, also a large amount of text messages may be sent from the management system to different terminal devices.

By sending a text message, the terminal device also receives an acknowledgement from the network and at the same time the information of the real time. If the network does not support this feature, the information of the real time may be obtained by sending a text message to oneself whereby, be reading the message, a clock time is obtained at which the network received the text message.

The invention is not restricted to the examples in view of which it is described. E.g. the telecommunication network, the described example of which is a GSM network, may be a network based on some other already applied technology or a future network, e.g. a UMTS network, or it may comprise e.g. a WLAN network. The data transfer may be accomplished by e.g. GPRS or WAP technologies or by content message or other services more advanced than the present SMS message. The terminal device includes then, instead of the GSM unit, a unit operating with corresponding technology. The primary object of the invention, however, is to provide a simple terminal device operating with low current consumption and low costs. Presently, this object is not achieved by new technologies but in the future at least some of them become so widely used that they will be the most advantageous technologies for this kind of solutions, too.

In addition to receiving and sending control and report data, also the programs of the terminal device may be updated via a connection set up in the mobile telecommunication network or via the IrDA interface.

The invention may vary within the scope of the accompanying claims.

1. Method of operation of a portable terminal device (L) in a mobile system in which method the terminal device includes:
means and functions (1, 5) for reading data from an object and for storing the data; and
means and functions (1, 6) for making the terminal device to operate as a terminal device of a mobile telecommunication network (24) for sending and receiving data; characterized in that, for minimizing the current consumption, the terminal device (Ln) is kept dominantly in a deep rest state (P0), in which the means and functions (1, 6) for making the terminal device to operate as a terminal device of a mobile telecommunication network (24) are totally passive, and said means and functions are activated for short periods (tc1 tc5) for sending or receiving data (R, SMS, 28, 28′), and the activation and operation of the terminal device for sending and receiving data is controlled individually by control data (28, 28′) which is sent to the terminal device (Ln) via the mobile communication network (24).

2. Method according to claim 1, characterized in that the control data (28, 28′) comprises data (B3) for activating the terminal device (Ln) at a certain time (t1) whereby a connection (H, R) may be set up to the terminal device for sending or receiving data.

3. Method according to claim 1, characterized in that the control data (28, 28′) comprises data (B7) for activating the terminal device (Ln) to set up a connection (H, R) for sending or receiving data in response to an information (G03) included in a data read from an object (Tn).

4. Method according to claim 1, characterized in that the control data (28, 28′) comprises data (D3) for activating the terminal device (Ln) to set up a connection (H, R) for sending or receiving data in response to starting (LD) the charging of the battery after a certain time (td) from the starting.

5. Method according to claim 1, characterized in that the control data (28, 28′) comprises data (A1) for denying the activation of the terminal device (Ln) in response to an information (H01) included in a data read from an object (Tn).

6. Method according to claim 1, characterized in that the control data is sent in a so called short message or similar (SMS) which is stored in the mobile telecommunication network (24) and is receivable by the terminal device when activated and a connection (S) having been set up to the mobile telecommunication network (24).

7. Method according to claim 1, characterized in that, for sending and receiving the data, including the control data, a data transfer connection is set up in the mobile telecommunication network using a suitable protocol.

8. Method according to claim 1, characterized in that the current consumption is minimized in the rest state (P0) so that essentially only an interruption clock (14) of a processor unit (1) of the terminal device (L) is active.
